(19) United States
(12) Patent Application Publication
(10) Pub. No.: US 2008/0191568 A1
(43) Pub. Date: Aug. 14, 2008

(54) STRUCTURE OF MOTOR GENERATOR

(75) Inventors: Katsuya KOBAYASHI, Okazaki-shi (JP); Yuji SHIMADA, Nissin-shi (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 12/029,730

(22) Filed: Feb. 12, 2008

(30) Foreign Application Priority Data
Feb. 13, 2007 (JP) 2007-032054

(51) Int. Cl. H02K 7/116; H02K 5/00

(52) U.S. Cl. 310/83; 310/89

(57) ABSTRACT

A motor generator that suppresses vibration that may be generated when power is transmitted through meshed gears includes: a stator; a case, a plurality of bolts that are used to attach the stator to the case; a rotor, rotatably mounted inside die stator; a first gear, coupled to and arranged concentrically with the rotor, for transferring power; and a second gear in meshing engagement with the first gear One of the plurality of bolts is positioned in the stator at a position to receive a reaction force, generated when power is transmitted through the meshed first and second gears and that acts radially outward from the central axis of the rotor on the stator, from one of the first gear and a the second gear. Thus, the transmission of undesirable vibration and noise to the passenger compartment is minimized.

### INCORPORATION BY REFERENCE

The disclosure of Japanese Patent Application No. 2007-032054 filed on Feb. 13, 2007 including the specification, drawings and abstract is incorporated herein by reference in its entirety.

### BACKGROUND OF THE INVENTION

1. Field of the Invention

The invention relates to a structure of a motor generator having a stator and a rotor, and, more particularly, to a measure for reducing vibration resulting from meshing between a gear arranged concentrically with the rotor and a meshing gear in meshing engagement with the gear.

2. Description of the Related Art

A motor generator of this type has a stator secured to a case and a rotor rotatably mounted inside the stator as described in, for example, Japanese Patent Application Publication No. 2005-318679. The rotor is coupled to a sun gear of a planetary gear mechanism that is arranged concentrically with the rotor for transmission of power. The sun gear is in meshing engagement with a plurality of pinion gears, which in turn is in meshing engagement with a ring gear arranged concentrically with the sun gear. In this case, the rotor is rotatably supported by the case via a bearing.

Such a motor generator may operate as both a motor, which is driven by electric power supplied thereto, and a power generator, which converts mechanical energy into electrical energy.

When the motor generator operates as a motor, a gear, such as the sun gear, is rotated by the output of the motor generator (motor), that is, the torque of the rotor, and the torque of the gear is transmitted to meshing gears, such as the pinion gears, in meshing engagement with the gear. At this time, vibration is generated by meshing of the gears (the gear and meshing gear). The vibration resulting from the meshing of the gears is caused by a change in the reaction force from the meshing gear which occurs when the torque of the gear is transmitted to the meshing gear. When the vibration resulting from a change in the reaction force from the meshing gear is transmitted to the rotor, the vibration is then transmitted to the case via the bearing and vibrates not only the case but also the stator. Then, the vibration of the case and the stator generates radiated noise, and uncomfortable vibration noise is transmitted to the passenger compartment.

When the motor generator operates as a power generator, vibration is generated by meshing of gears when the torque from the ring gear is transmitted from a plurality of meshing gears, such as the pinion gears, in meshing engagement with the ring gear to a gear such as the sun gear. The vibration resulting from the meshing of the gears is also caused by a change in the reaction force from the meshing gears which occurs when the torque of the meshing gears is transmitted to the gear When the vibration resulting from a change in the reaction force from the meshing gears is transmitted to the rotor, the vibration is transmitted to the case via the bearing and vibrates the case and the stator. Then, the vibration of the case and the stator generates radiated noise, and uncomfortable vibration noise is transmitted to the passenger compartment.

### SUMMARY OF THE INVENTION

The present invention provides a structure of a motor generator that suppresses vibrations that may be generated by meshing of gears to prevent transmission of uncomfortable vibration noise to the passenger compartment.

One aspect of the present invention is based on the structure of a motor generator having a stator, secured to a case, and a rotor that is rotatably mounted inside the stator. The rotor is coupled to a gear arranged concentrically with the rotor for transmission of power. When power is transmitted through meshing of the gear and a meshing gear in meshing engagement with the gear, a reaction force from one of the gear and the meshing gear acts radially outward from the central axis of the rotor on the stator having directivity. One of a plurality of bolts that secures the stator to the case is positioned in a reaction force receiving part of the stator on which the radially outward reaction force from either the gear or the meshing gear acts having directivity.

With this specific feature, the stator acts as a mass damper. Thus, when the motor generator functions as a motor, a change in the reaction force from the meshing gear resulting from meshing of the gears (the gear and meshing gear) when the torque of the gear is transmitted to the meshing gear is suppressed, and, when the motor generator operates as a power generator, a change in the reaction force from the gear resulting from meshing of the gears when the torque of the meshing gear is transmitted to the gear is suppressed. As a result, even when vibration caused by a change in the reaction force from one of the gear and the meshing gear is transmitted to the rotor, transmission of the vibration to the case and stator via a bearing is reduced, and transmission of uncomfortable vibration noise to the passenger compartment is minimized.

To put it briefly, the stator is allowed to function as a mass damper by positioning one of a plurality of bolts that secure the stator to the case in a reaction force receiving part of the stator on which a reaction force from one of the gear and the meshing gear acts to suppress vibration of the case and the stator which may occur when vibration resulting from a change in the reaction force from one of the gear and the meshing gear is transmitted to the rotor in order to prevent transmission of uncomfortable vibration noise to the passenger compartment.

### BRIEF DESCRIPTION OF THE DRAWINGS

The foregoing and further features and advantages of the invention will become apparent from the following description of example embodiments with reference to the accompanying drawings, wherein like numerals are used to represent like elements, and wherein:

FIG. 1 is a skeleton view of a power transmission device provided with a motor generator according to one embodiment of the present invention;

FIG. 2 is a vertical cross-sectional front view of a second motor generator;

FIG. 3 is a vertical cross-sectional side view of the second motor generator, taken along the line III-III of FIG. 2;

FIG. 4 is a vertical cross-sectional front view of a first motor generator; and

FIG. 5 is a vertical cross-sectional front view of a motor generator according to a modified embodiment of the present invention.

### DETAILED DESCRIPTION OF EMBODIMENTS

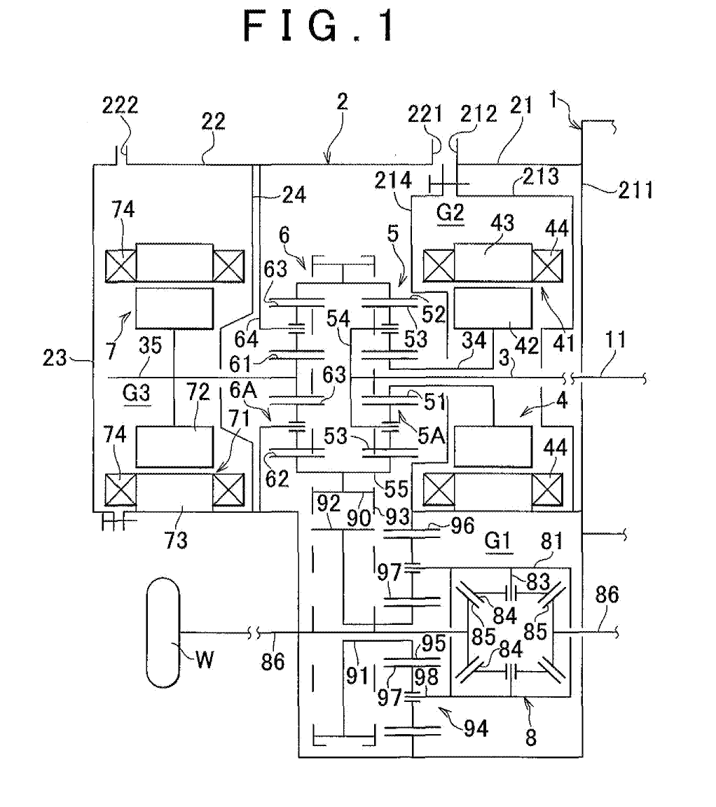

FIG. 1 is a skeleton view illustrating a power transmission device of an FF (front engine front drive) hybrid vehicle provided with a motor according to an embodiment of the present invention. In FIG. 1, as the engine 1, an internal combustion engine such as gasoline engine, diesel engine, LPG engine, methanol engine, or hydrogen engine can be used.

In this embodiment, a case in which a gasoline engine is used as the engine 1 is described for convenience sake. The engine 1 is a device which outputs power obtained by combusting fuel through a crankshaft 11 and has an intake device, an exhaust device, a fuel injection device, an ignition device, a cooling device, and so on. The crankshaft 11 extends horizontally in the vehicle width direction.

A hollow transaxle case 2 as a case is attached to an outer wall of the engine 1. The transaxle case 2 has an engine side housing 21, an extension housing 22, and an end cover 23. The engine side lousing 21, the extension housing 22, and the end cover 23 are obtained by forming a metal material such as aluminum into a desired shape. The engine 1 and the engine side housing 21 are secured to each other with a first open end 211 of the engine side housing 21 in contact with the engine 1.

The extension housing 22 is located between the engine side housing 21 and the end cover 23. The engine side housing 21 and the extension housing 22 are secured to each other with a second open end 212 of the engine side housing 21 in contact with a first open end 221 of the extension housing 22. The end cover 23 is attached to close a second open end 222 of the extension housing 22, and the end cover 23 and the extension housing 22 are secured to each other.

The transaxle case 2 has an inner space G1, in which an input shaft 3, a first motor generator 4, a power combining mechanism 5, a transmission mechanism 6, and a second motor generator 7 are disposed. The input shaft 3 and the crankshaft 11 are arranged concentrically with each other. Between the input shaft 3 and the crank shaft 11, a damper mechanism (not shown) is disposed for eliminating or absorbing the torque difference between the shafts 3 and 11. The first motor generator 4 is located around the input shaft 3, and the second motor generator 7 is located farther from the engine 1 than the first motor generator 4. In this case, the input shaft 3 extends to the power combining mechanism 5.

That is, the first motor generator 4 is located between the engine 1 and the second motor generator 7. The first motor generator 4 has the function of a motor which is driven by electric power supplied thereto (power running function) and the function of a power generator which converts mechanical energy into electrical energy (regeneration function). The second motor generator 7 has the function of a power generator in addition to the function of a motor. As an electric power supply device for supplying electric power to the first motor generator 4 and the second motor generator 7, an electrical storage device such as battery or capacitor, or a fuel cell can be used.

The installation position of the first motor generator 4 and the configuration of the first motor generator 4 are described below in detail. A partition 213 extending toward the engine 1 and then toward the input shaft 3 is formed on an inner wall of the engine side housing 21. A case cover 214 is secured to the partition 213. The case cover 214 extends away from the engine 1 and then toward the input shaft 3. The first motor generator 4 is located in a space G2 defined by the partition 213 and the case cover 214. The first motor generator 4 has a stator 41 secured to the transaxle case 2, and a rotor 42 rotatably mounted inside the stator 41. The stator 41 has an iron core 43 secured to the partition 213, and coils 44 wound around the iron core 43.

The stator 41 and the rotor 42 are formed by stacking a plurality of electrical steel plates with a prescribed thickness in their thickness direction. The plurality of electrical steel plates are stacked in the axial direction of the input shaft 3. A hollow shaft 34 is mounted on the input shaft 3. The input shaft 3 and the hollow shaft 34 are rotatable relative to each other. The rotor 42 is connected to the outer periphery of the hollow shaft 34.

The power combining mechanism (in other words, power distributing mechanism) 5 is located between the first motor generator 4 and the second motor generator 7. The power combining mechanism 5 has what is called a single pinion type planetary gear mechanism 5A. That is, the planetary gear mechanism 5A has a sun gear 51, a ring gear 52 disposed concentrically with the sun gear 51, and a carrier 54 supporting a pinion gear 53 in meshing engagement with the sun gear 51 and the ring gear 52. The sun gear 51 and the hollow shaft 34 are connected to each other, and the carrier 54 is connected to the power combining mechanism 5 side end of the input shaft 3. The ring gear 52 is formed on the inner periphery of an annular member (in other words, cylindrical member) 55 disposed concentrically with the input shaft 3.

The second motor generator 7 is located around a shaft 35 disposed concentrically with the input shaft 3. The installation position of the second motor generator 7 and the configuration of the second motor generator 7 are described below in detail. A partition 24 extending toward the shaft 35 is formed on an inner wall of the extension housing 22. The second motor generator 7 is located in a space G3 defined by the extension housing 22, the partition 24 and the end cover 23. In this case, the shaft 35 extends to the transmission mechanism 6.

The second motor generator 7 has a stator 71 secured to the transaxle case 2, and a rotor 72 rotatably mounted inside the stator 71. The stator 71 has an iron core 73, and coils 74 wound around the iron core 73. The stator 71 and the rotor 72 are formed by stacking a plurality of electrical steel plates with a prescribed thickness in their thickness direction. The plurality of electrical steel plates are stacked in the axial direction of the shaft 35. The rotor 72 is connected to the outer periphery of the shaft 35. As a result, the first motor generator 4, the power combining mechanism 5, and the second motor generator 7 are concentrically arranged.

The transmission mechanism 6 is located between the power combining mechanism 5 and the second: motor generator 7 in the axial direction of the shaft 35, and the transmission mechanism 6 has what is called a single pinion type planetary gear mechanism 6A. That is, the planetary gear mechanism 6A has a sun gear 61 mounted on the transmission mechanism 6 side end of the shaft 35, a ring gear 62 disposed concentrically with the sun gear 61 and formed on an inner periphery of the annular member 55, and a carrier 64 supporting a pinion gear 63 in meshing engagement with the sun gear 61 and the ring gear 62. In this case, the carrier 64 is secured to the transaxle case 2.

A differential 8 is disposed in the transaxle ease 2. The differential 8 has a plurality of pinion gears 84 attached to a differential case 81 via a pinion shaft 83 and coupled to each other, side gears 85 in meshing engagement with the plurality of pinion gears 84, and two front driveshafts 86 connected to the side gears 85. Front wheels W (only one of them is shown in FIG. 1) are connected to corresponding front driveshafts 86. As described above, the transmission mechanism 6 and the differential 8 are integrally incorporated in the transaxle case 2 to form what is called a transaxle.

A drive sprocket 90 is formed on the outer periphery of the annular member 55. A hollow shaft 91 is mounted on one of the front driveshafts 86. The hollow shaft 91 and the corresponding front driveshaft 86 are rotatable relative to each other, and a driven sprocket 92 is formed on the hollow shaft 91. A chain 93 is entrained between the drive sprocket 90 and the driven sprocket 92.

In addition, the driven sprocket 92 and the differential 8 are connected by a planetary gear mechanism 94 for transmission of power. The planetary gear mechanism 94 has a sun gear 95 formed on the hollow shaft 91, a ring gear 96 formed on and secured to the transaxle case 2, and a carrier 98 supporting a pinion gear 97 in meshing engagement with the sun gear 95 and the ring gear 96. The carrier 98 and the differential case 81 are connected to each other for unitary rotation.

Power transmission between the annular member 55 and the differential 8 is accomplished as described below. When power from at least one of the engine 1 and the second motor generator 7 is transmitted to the annular member 55, the torque of the annular member 55 is transmitted to the sun gear 95 of the planetary gear mechanism 94 via the drive sprocket 90, the chain 93, the driven sprocket 92, and the hollow shaft 91. Then, the rotation of the sun gear 95 is transmitted at a reduced rate to the carrier 98 and the differential case 81. In this case, the direction of rotation of the sun gear 95, and the direction of rotation of the carrier 98 and the differential case 81 are the same. The shaft 35 and the input shaft 3 arranged concentrically with each other are disposed parallel to the front driveshafts 86.

Although not specifically shown, an electronic control device for controlling the entire vehicle is provided. The electronic control device is a microcomputer composed essentially of an arithmetic processing unit (CPU or MPU), storage devices (RAM and ROM), and an input-output interface. Signals from an ignition switch, an engine rotational speed sensor, a brake switch, a vehicle speed sensor, an accelerator opening sensor, a shift position sensor, a resolver that detects the rotational speeds of the first motor generator 4 and the second motor generator 7 and so on are input to the electronic control device. Signals for controlling the intake air amount, fuel injection amount, and ignition timing of the engine 1, and signals for controlling the outputs of the first motor generator 4 and the second motor generator 7 are output from the electronic control device.

Here, the correspondence relationship between the configuration of the embodiment shown in FIG. 1 amid the configuration of the present invention is described. Each of the first motor generator 4 functioning as a power generator, and the second motor generator 7 functioning as a motor, may be regarded as corresponding to the motor generator of the present invention. Each of the central axis of the hollow shaft 34, to which the rotor 42 of the first motor generator 4 is connected, and the central axis of the shaft 35, to which the rotor 72 of the second motor generator 7 is connected, may be regarded as corresponding to the central axis of the rotor of the present invention. In addition, each of the sun gear 51 of the power combining mechanism 5 (the planetary gear mechanism 5A) and the sun gear 61 of the transmission mechanism 6 (planetary gear mechanism 6A) may be regarded as corresponding to the gear of the present invention, and each of the pinion gear 53 of the power combining mechanism 5 (the planetary gear mechanism 5A) and the pinion gear 63 of the transmission mechanism 6 (planetary gear mechanism 6A) may be regarded as corresponding to the meshing gear of the present invention.

In a hybrid vehicle constituted as described above, the required torque to be transmitted to the front wheels W is calculated based on conditions such as vehicle speed and accelerator opening, and the engine 1, the first motor generator 4, and the second motor generator 7 are controlled based on the result of calculation. When the torque output from the engine 1 is transmitted to the front wheels W, at least one of the power (in other words, torque) transmitted from the crankshaft 11 via the input shaft 3, the carrier 54, the pinion gear 53, and the ring gear 52 and the power transmitted from the second motor generator 7 via the shaft 35, the sun gear 61, the pinion gear 63, and the ring gear 62 is transmitted to the annular member 55. When the torque of the engine 1 is transmitted to the carrier 54, the first motor generator 4 can be allowed to function as a power generator to charge an electrical storage device (not shown) with electric power generated thereby.

In addition, it is possible to drive the second motor generator 7 as a motor and transmit the power therefrom to the power distributing mechanism 5. The power from the second motor generator 7 is transmitted to the sun gear 61 of the transmission mechanism 6 via the shaft 35, the carrier 64 acts as a reaction force element. Then, the power is transmitted from the sun gear 61 at a reduced rate in such a direction as to rotate the ring gear 62 in a direction opposite the direction of rotation of the sun gear 61. As a result, power from the engine 1 and power from the second motor generator 7 are both input to the power combining mechanism 5 and combined therein, and the combined power is transmitted to the front wheels W.

In this embodiment, the torque of the second motor generator 7 is transmitted to the power combining mechanism 5 at an increased rate by reducing the rotational speed thereof. Thus, the size or rating of the second motor generator 7 (more specifically, the size of the second motor generator 7 in the radial direction of the shaft 35, the length of the second motor generator 7 in the axial direction of the shaft 35, etc.) does not have to be designed large enough preparing for a situation in which the output from the second motor generator 7 needs to be increased, and the second motor generator 7 can be therefore reduced in size and weight.

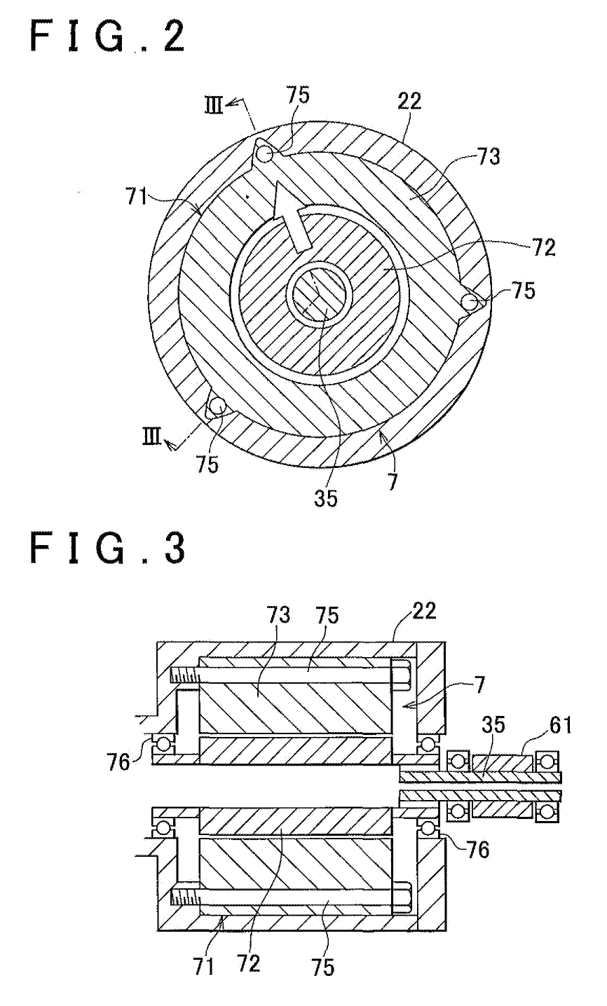

One characteristic feature of the present invention is that the stator 71 of the second motor generator 7 is attached to the extension housing 22 by bolts 75, extending therethrough at three equally circumferentially spaced locations as shown in FIG. 2 and FIG. 3. The rotor 72 is rotatably supported by the extension housing 22 via bearings 76 at axial opposite ends of the rotor 72. When the power from the second motor generator 7 is transmitted from the sun gear 61 of the transmission mechanism 6 to the pinion gear 63 via the shaft 35, since the carrier 64 functions as a reaction force element because of meshing between the sun gear 61 and the pinion gear 63, a reaction force from the pinion gear 63 acts on the rotor 72 via the sun gear 61 and the shaft 35. The reaction force from the pinion gear 63 acts radially outward (in the direction of the arrow shown in FIG. 2) from the central axis of the rotor 72 on the stator 71 having directivity via the sun gear 61 and the shaft 35. One bolt 75 of the three is positioned in a reaction force receiving part of the stator 71 on which the reaction force from the pinion gear 63 acts radially outward from the central axis of the rotor 72.

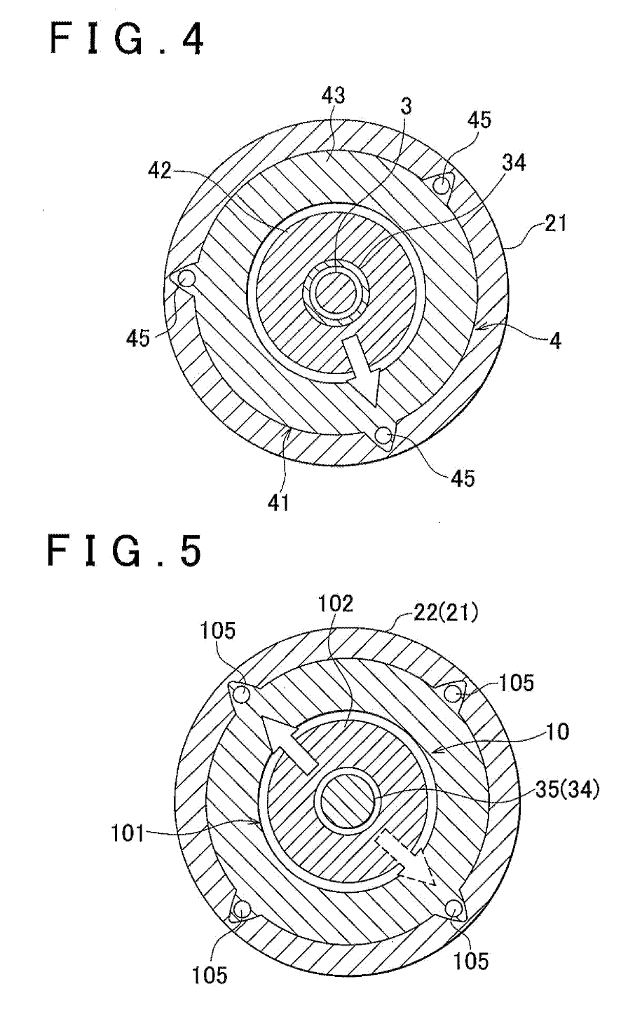

The stator 41 of the first motor generator 4 is also attached to the engine side housing 21 by bolts 45 extending therethrough at three equally circumferentially spaced locations as shown in FIG. 4. The rotor 42 is rotatably supported by the engine side housing 21 via bearings at axial opposite ends of the rotor 42. When the torque from the engine 1 is transmitted to the rotor 42 of the first motor generator 4 via the carrier 54, the pinion gear 53, the sun gear 51, and the hollow shaft 34, since the rotor 42 functions as a reaction force element because of meshing between the sun gear 51 and the pinion gear 53, a reaction force from the sun gear 51 acts on the rotor 42 via the hollow shaft 34. The reaction force from the sun gear 51 acts radially outward (in the direction of the arrow shown in FIG. 4) from the central axis of the rotor 42 on the stator 41 having directivity via the hollow shaft 34. One bolt 45 of the three is positioned in a reaction force receiving part of the stator 41 on which the reaction force from the sun gear 51 acts radially outward from the central axis of the rotor 42.

In this case, the reaction force from the pinion gear 63 acting radially outward from the central axis of the rotor 72 of the second motor generator 7 is greater than the reaction force from the sun gear 51 acting radially outward from the central axis of the rotor 42 of the first motor generator 4, and the reaction forces act in the opposite directions.

Thus, in the above embodiment, since one of the three, circumferentially equally spaced bolts 75 for securing the stator 71 of the second motor generator 7 to the extension housing 22 is positioned in a reaction force receiving part of the stator 71 (the part in the direction of the arrow shown in FIG. 2) on which a reaction force from the pinion gear 63 acts radially outward from the central axis of the rotor 72 (the central axis of the shaft 35), the stator 71 and the one of the three bolts 75 act as a mass damper. Therefore, when the second motor generator 7 functions as a motor, a large change in the reaction force from the pinion gear 63 resulting from meshing between the gears 61 and 63 when the torque of the sun gear 61 is transmitted to the pinion gear 63 can be suppressed. As a result, even when vibration caused by a change in the reaction force from the pinion gear 63 is transmitted to the rotor 72, transmission of the vibration to the extension housing 22 and the stator 71 via the bearings 76 is reduced, and transmission of uncomfortable vibration noise to the passenger compartment is minimized.

In addition, since one of the three, circumferentially equally spaced bolts 45 for securing the stator 41 of the first motor generator 4 to the engine side housing 21 is positioned in a reaction force receiving part of the stator 41 (the part in the direction of the arrow shown in FIG. 4) on which a reaction force from the sun gear 51 acts radially outward from the central axis of the rotor 42 (the central axis of the hollow shaft 34), the stator 41 and the one of the three bolts 45 act as a mass damper. Therefore, when the first motor generator 4 functions as a power generator, a change in the reaction force from the sun gear 51 resulting from meshing between the gears 53 and 51 when the torque of the pinion gear 53 is transmitted to the sun gear 51 can be also suppressed. As a result, even when vibration caused by a change in the reaction force from the sun gear 51 is transmitted to the rotor 42, transmission of vibration to the engine side housing 21 and the stator 41 via the bearings is reduced, and transmission of uncomfortable vibration noise to the passenger compartment is minimized.

The present invention is not limited to the above embodiment and includes other various modifications. For example, while the bolts 75 for securing the stator 71 of the second motor generator 7 to the extension housing 22 and the bolts 45 for securing the stator 41 of the first motor generator 4 to the engine side housing 21 are provided at three equally spaced locations around the stators 71 and 41 in the above embodiment, bolts 105 for securing a stator 101 of a motor generator 10 to the extension housing 22 or the engine side housing 21 may be provided at four equally spaced locations around the stator 101 such that two bolts 105 of the four spaced 180° apart from each other are respectively positioned in a reaction force receiving part of the stator 101 (the part in the direction of the solid line arrow shown in FIG. 5) on which a reaction force from the pinion gear 63 acts radially outward from the central axis of a rotor 102 when the motor generator 10 functions as a motor and a reaction force receiving part of the stator 101 (the part in the direction of the broken line arrow shown in FIG. 5) on which a reaction force from the sun gear 51 acts radially outward from the central axis of a rotor 102 when the motor generator 10 functions as a power generator. In this case, because the same stator 101 may be used when the motor generator 10 operates as either a motor or a power generator, one stator 101 may be used for both purposes.

What is claimed is:

1. A motor generator comprising:
a stator;
a case;
a plurality of bolts, used to attach the stator to the case;
a rotor, rotatably mounted inside the stator;
a first gear, coupled to and arranged concentrically with the rotor, for transferring power; and
a second gear in meshing engagement with the first gear;
wherein, one of the plurality of bolts is positioned in the stator at a position to receive a reaction force, generated when power is transmitted through the meshed first and second gears and that acts radially outward from the central axis of the rotor on the stator having directivity, from one of the first gear and a the second gear.

2. The motor generator according to claim 1, wherein the number of the bolts is three.

3. The motor generator according to claim 1, wherein the number of the bolts is four.
